(19) United States
(12) Patent Application Publication
(10) Pub. No.: US 2023/0264306 A1
(43) Pub. Date: Aug. 24, 2023

(54) JOINING DEVICE FOR JOINING COMPONENTS ON A SHAFT

(71) Applicant: MAHLE International GmbH, Stuttgart (DE)

(72) Inventors: Antonio Menonna, Ditzingen (DE); Stefan Morgenstern, Niederwiesa (DE)

(21) Appl. No.: 18/111,418

(22) Filed: Feb. 17, 2023

(30) Foreign Application Priority Data
Feb. 22, 2022 (DE) 20 2022 100 979.1

(51) Int. Cl. B23P 19/04

(52) U.S. Cl. CPC B23P 19/04; F16C 2226/14; F16C 2226/12

(57) ABSTRACT

A joining device for joining components on a shaft, e.g., for joining camshaft components on a camshaft tube, is disclosed. The joining device includes a joining device body composed of a material with a heat expansion coefficient that is lower than 10.0 μm/m° C. The heat expansion coefficient of the joining device is smaller than that of the components and/or the shaft.

### CROSS-REFERENCE TO RELATED APPLICATION

This application claims priority to German Application No. DE 20 2022 100 979.1 filed on Feb. 22, 2022, the contents of which are hereby incorporated by reference in its entirety.

### TECHNICAL FIELD

The present invention relates to a joining device for joining components on a shaft, in particular for joining camshaft components on a camshaft tube.

### BACKGROUND

When joining components on a shaft, for example when joining camshaft components on a camshaft tube, a highly precise axial dimension is desirable, which however does not only depend on a positioning accuracy of the joining axis but in major parts also on temperature fluctuations of the components to be joined and of the joining device itself or of a holding device of the same. A material of the components to be joined or of the shaft is generally specified by their function later on.

In the case of built camshafts for example, the components to be joined such as for example a drive element, a camshaft tube as well as hub components generally consist of steel. Other components, such as for example sensor wheels or output elements are often formed out of sinter materials, as a result of which a precise axial dimension can be set only with difficulty and thus with high cost or not at all.

The present invention therefore deals with the problem of stating a joining device by means of which in particular the disadvantages known from the prior art can be overcome.

According to the invention, this problem is solved through the subject of the independent claim(s). Advantageous embodiments are subject of the dependent claims.

### SUMMARY

The present invention is based on the general idea of forming a joining device for joining components on a shaft, for example for joining camshaft components on a camshaft tube, out of a material the heat expansion coefficient α of which is smaller than that of steel (12 μm/m° C.), for example smaller than 10.0 μm/m° C. The lower the heat expansion coefficient α of the joining device is, the more precisely can the components to be joined be joined with respect to their axial dimension or with respect to their axial position on the shaft. When for example multiple components are simultaneously joined on the shaft using the joining device according to the invention, for example by means of a thermal shrink fit, this can be realised particularly advantageously using the joining device according to the invention since here the different heat input of the individual components to be joined, because of a component variance or process fluctuations during the heating, has almost no effects on the joining device and thus also on the axial dimensions to be achieved, which is why not only a dimensional variance with respect to the reference surface, but also a dimensional variance between individual components to be joined can be significantly reduced.

A further advantage with a joining device having a very small heat expansion coefficient is that the components to be joined by the same, almost uninfluenced by temperature fluctuations, remain better in terms of a coaxiality between tube axis and joining axis, which likewise results in an improved axial dimension precision.

Because of the significantly increased precision with regard to the axial dimension that can be achieved, rejects can also be reduced and because of this a significant cost reduction, in particular also by omission of an additional process for producing a precise axial dimension, be achieved.

In an advantageous further development of the joining device according to the invention, the same is formed out of a silicon nitride ceramic (Si₃N₄) having a heat expansion coefficient α of 2.5 μm/m° C. Assuming the heat expansion coefficient α of steel with approximately 12.0 μm/m° C., a joining device out of a silicon nitride ceramic can accordingly have a heat expansion coefficient of merely 21% of that of steel, as a result of which a significantly more precise axial positioning of the components to be joined is made possible.

In an alternative embodiment of the joining device according to the invention, the same is formed out of an iron nickel alloy having a heat expansion coefficient α of 1.7 μm/m° C. A joining device out of an iron nickel alloy thus has merely 14% of the heat expansion coefficient of steel, as a result of which the accuracy in particular with respect to a joining device out of steel or a silicon nitride ceramic can be significantly increased even further.

Practically, the joining device is formed for thermally joining the components on the shaft. For this purpose, the joining device can comprise for example an additional heating device which makes possible a further heating of the components to be joined during the joining operation. Particularly during thermal joining, the joining device with its significantly reduced heat expansion coefficient brings out all its advantages.

Further important features and advantages of the invention are obtained from the subclaims, from the drawings and from the associated figure description by way of the drawings.

It is to be understood that the features mentioned above and still to be explained in the following cannot only be used in the respective combination stated, but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

There it shows, in each case schematically

FIG. 1 a joining device according to the invention while joining multiple camshaft components on a camshaft tube,

FIG. 2 a detail representation from FIG. 1.

### DETAILED DESCRIPTION

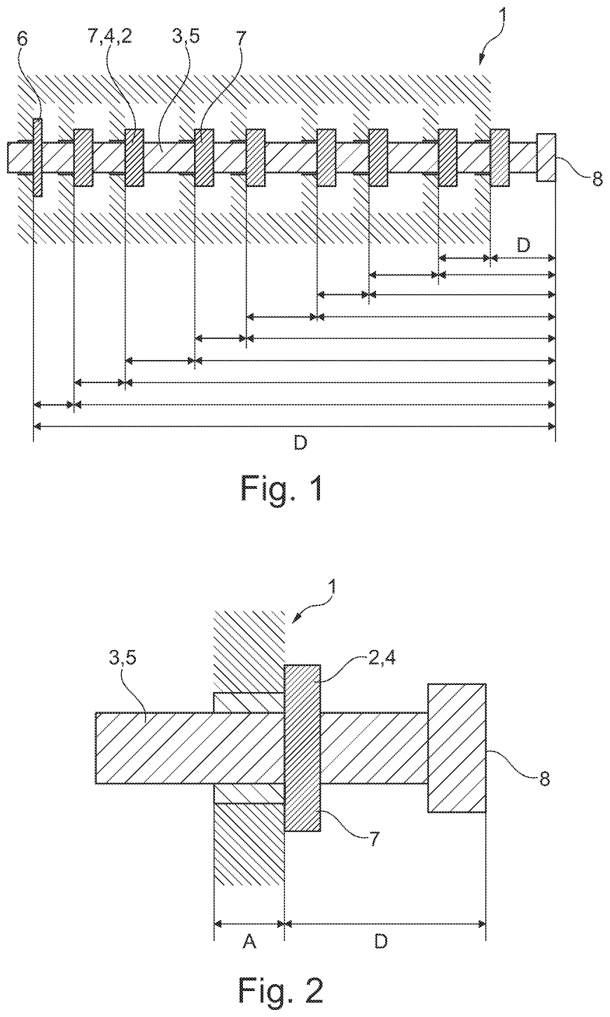

According to the FIGS. 1 and 2, a joining device 1 according to the invention for joining components 2 on a shaft 3, in particular for joining camshaft components 4 on a camshaft tube 5, comprises a material having a heat expansion coefficient α of <10.0 μm/m° C. Concretely, this means that the joining device 1 is formed out of such a material, wherein a heat expansion coefficient α of approximately 12.0 μm/m° C. corresponds to that of steel. This means that the joining device 1 is formed out of a material the heat expansion coefficient α of which is smaller than that of the components 2 or the shaft 3 to be joined. Particularly preferably, the joining device 1 is formed out of a silicon nitride ceramic (Si₃N₄) having a heat expansion coefficient α of 2.5 μm/m° C.

In a further advantageous and alternative embodiment of the joining device 1 according to the invention, the same is formed out of an iron nickel alloy having a heat expansion coefficient α of merely 1.7 μm/m° C. This means that such a joining device 1 merely has a ¼ or less than ⅕ of the heat expansion of steel, i.e. of the components 2 to be joined on the shaft 3, as a result of which temperature-induced fluctuations of the heat expansion of the joining device 1 can be minimised.

A material of the camshaft components 4 to be joined is generally specified, wherein for example a drive element 6, the camshaft tube 5 and for example cams 7 are generally made of steel. Other camshaft components 4, such as for example sensor wheels or output elements can be produced for example out of a sinter material. In order to minimise the influence of temperature fluctuations of the joining device 1, the same is now produced out of a material the heat expansion coefficient α of which is significantly lower than the heat expansion coefficient α of the component 2 and of the shaft 3 to be joined.

In addition it is true that the greater a distance dimension D between a reference surface 8 and the joining device 1 is, the greater is also the effect that can be achieved with the joining device 1 formed according to the invention. Upon a simultaneous joining in the joining device 1 of multiple, in particular even distinct camshaft components 4 out of a material which has a significantly lower heat expansion coefficient α, it is particularly advantageous since here the different heat input of the camshaft components 4, because of the component variance or process fluctuations of the heating, has almost no effect on the joining device 1 and thus also on the axial dimensions and therefore not only the dimensional variance of the reference surface 8 but also the dimensional variance between the individual camshaft components 4 can be reduced.

When for example the differential dimension D amounts to 70 mm between the joining device 1 and the reference surface 8 of the shaft 3, the expansion variance of the shaft 3, provided the same is formed out of steel and has a heat expansion coefficient α of 12 μm per m and ° C. at +/−10° C. temperature differential is 16.8 μm.

A further advantage also is that the joining device 1 and because of this also the camshaft components 4 to be joined to the same, almost uninfluenced by temperature fluctuations, remain better in terms of a coaxiality between tube axis and joining axis, which in turn results in an improved axial dimension precision. Because of this, rejects can also be reduced as a result of which a substantial cost reduction through the omission for example of an additional process that would be required for producing the precise axial dimension can be achieved.

All in all, a significantly improved axial positioning of components 2 to be joined on a shaft 3 by means of a thermal joining fit can be achieved with the joining device 1 according to the invention. The joining device 1 can also be formed for press-fitting the components 2 on the shaft 3, in particular with a longitudinal pressing method.

The temperature-induced expansion variance of the joining device 1 in a portion A (see FIG. 2), which extends 30 mm in the axial direction, is 7.2 μm at +/−10° C. in the case of steel. With a joining device formed out of a silicon nitride ceramic having a heat expansion coefficient α of 2.5 μm per m and ° C., the expansion variance of the portion A amounts to 1.5 μm at +/−10° C., while the same, with a joining device 1 formed out of an iron nickel alloy having a heat expansion coefficient α of 1.7 μm per m ° C. amounts to merely 1 μm at +/−10° C. temperature differential.

This produces a dimensional variance for +/−10° C. for a joining device 1 out of steel of +/−12 μm, for a joining device 1 out of a silicon nitride ceramic of +/−9.9 μm and for a joining device 1 out of an iron nickel alloy of +/−9.4 μm.

These values already show that with same assumed temperature variance of +/−10° C. of the camshaft tube 5 and of the joining device 1, a tolerance of +/−10 μm with a joining device 1 out of steel is not attainable even because of the heat expansion alone. However, this would be attainable with a joining device 1 formed out of a silicon nitride ceramic or iron nickel alloy.

1. A joining device for joining components on a shaft, comprising a joining device body composed of a material with a heat expansion coefficient that is lower than 10.0 μm/m° C.

2. The joining device according to claim 1, wherein the material of the joining device body is a silicon nitride ceramic (Si₃N₄) having a heat expansion coefficient of 2.5 μm/m° C.

3. The joining device according to claim 1, wherein the material of the joining device body is an iron nickel alloy having a heat expansion coefficient of 1.7 μm/m° C.

4. The joining device according to claim 1, wherein the joining device body is structured for thermally joining the components on the shaft.

5. The joining device according to claim 1, wherein the joining device body is structured for press-fitting the components on the shaft.

6. The joining device according to claim 1, wherein the joining device body includes a plurality of openings for receiving the shaft, the plurality of openings being surrounded by the material with the heat expansion coefficient that is lower than 10.0 μm/m° C.

7. The joining device according to claim 1, wherein the joining device body includes transverse walls arranged axially spaced apart at a distance from one another relative to a shaft axis, and wherein transverse walls have a respective opening for receiving the shaft and are composed of the material with the heat expansion coefficient that is lower than 10.0 μm/m° C.

8. The joining device according to claim 7, wherein the transverse walls are composed of a silicon nitride ceramic (Si₃N₄) having a heat expansion coefficient 2.5 μm/m° C.

9. The joining device according to claim 7, wherein the transverse walls are composed of an iron nickel alloy having a heat expansion coefficient of 1.7 μm/m° C.

10. The joining device according to claim 1, wherein the heat expansion coefficient of the material of the joining device body is smaller than that of the components and the shaft.

11. A joining device for joining camshaft components on a camshaft tube, comprising:
a joining device body composed of a material with a heat expansion coefficient that is lower than 10.0 μm/m° C.

12. The joining device according to claim 11, wherein the material of the joining device body is a silicon nitride ceramic (Si₃N₄) having a heat expansion coefficient 2.5 μm/m° C.

13. The joining device according to claim 11, wherein the material of the joining device body is an iron nickel alloy having a heat expansion coefficient of 1.7 μm/m° C.

14. The joining device according to claim 11, wherein the joining device body includes transverse walls arranged axially spaced apart at a distance from one another relative to a shaft axis, and wherein transverse walls have a respective opening for receiving the shaft and the transverse walls are composed of the material with the heat expansion coefficient that is lower than 10.0 μm/m° C.

15. The joining device according to claim 14, wherein the transverse walls have an axial extent of 30 mm.

16. The joining device according to claim 11, wherein the joining device body is structured for thermally joining the camshaft components on the camshaft tube.

17. The joining device according to claim 11, wherein the joining device body is structured for press-fitting the camshaft components on the camshaft tube.

18. The joining device according to claim 11, wherein the camshaft components include at least one of a drive element and a cam.

19. The joining device according to claim 11, the heat expansion coefficient of the material of the joining device body is smaller than that of the camshaft components and the camshaft tube.

20. The joining device according to claim 11, wherein the joining device body includes a plurality of openings for receiving the camshaft tube, the plurality of openings being surrounded by the material with the heat expansion coefficient that is lower than 10.0 μm/m° C.
